(19) United States
(12) Patent Application Publication
(10) Pub. No.: US 2015/0253053 A1
(43) Pub. Date: Sep. 10, 2015

(54) PROCESSING A LIQUID FOR STORAGE AND SUBSEQUENT FREEZING TO PRODUCE A VISUALLY CLEAR FROZEN LIQUID

(71) Applicant: Elebev Holdings, LLC, Miami, FL (US)

(72) Inventors: Nestor C. Villalobos, Miami, FL (US); Stephen Giorgio, Ridgefield, CT (US)

(21) Appl. No.: 14/642,152

(22) Filed: Mar. 9, 2015

Related U.S. Application Data
(60) Provisional application No. 61/949,654, filed on Mar. 7, 2014.
(60) Provisional application No. 62/029,081, filed on Jul. 25, 2014.

(51) Int. Cl. F25C 1/18; B65B 3/00; C02F 1/04; C02F 1/44; C02F 9/00; C02F 1/20

(52) U.S. Cl. CPC F25C 1/18; C02F 9/00; C02F 1/20; C02F 1/04; C02F 1/441; B65B 3/00; C02F 2101/10

(57) ABSTRACT

A method of processing a liquid for storage within a container in a manner which facilitates producing a substantially visually clear frozen product. The liquid and the container may each be commercially sterilized and the concentrations of both dissolved solids and gases are reduced to a predetermined concentration. Upon the reduction of the dissolved gases within the liquid it is heated prior to substantially completely filling a container with the processed liquid. The container is then sealed with a fluid tight seal, thereby rendering it ready for storage, transportation and subsequent freezing to produce a substantially visually clear frozen product.

### BACKGROUND OF THE INVENTION

1. Field of the Invention

The present invention is directed to a method of processing a liquid, specifically including but not limited to water, for prolonged storage within containers at room or ambient temperatures. Further, when transported to a location for use, the liquid may be frozen within the respective containers resulting in a substantially visually clear frozen product.

2. Description of the Related Art

Visually, clear ice is more desirable than cloudy ice when served in cocktails, used in ice sculptures, or for any of a variety of other purposes where ice is consumed or observed. Furthermore, cloudy ice is less dense which ultimately causes the ice to melt faster which, when used for the cooling of beverages, is disadvantageous.

Utilizing conventional techniques and procedures to freeze water, as well as other liquids, the resulting ice or frozen product is invariably “cloudy”. One reason is that ice freezes from the outside thus causing dissolved gases and solids to get trapped near the center of the frozen product, which ultimately produces cloudiness. Another reason is the formation of ice fractures during the freezing process. More specifically, if ice is stressed during or after the freezing process, it creates small fractures which lead to the ice becoming more opaque. Many times either tap water or bottled water is used to fill ice molding structures. Both sources of water typically contain an amount of dissolved solids, such as minerals. It is also well established that minerals impart taste, which may be undesirable when mixed with beverages. As such, when ice is made from water containing minerals it invariably modifies the taste of the beverage with which it is served.

Additional problems associated with the manufacture and distribution of ice relate to the transportation and delivery thereof to locations where the ice is actually used. More specifically, the distribution of ice typically involves the filling of water and or other liquids into ice molds and then freezing the liquid. As a result, increased labor and transportation costs are incurred based on the fact that the frozen liquid must be maintained at a substantially reduced temperature during packaging, storage and transportation. Effective and efficient transportation of liquids subsequent to the loading into the molding structures, but prior to freezing, has not been perfected.

As set forth above, it is generally acknowledged that most ice products of the type used for cooling beverages and other food products is cloudy or less than visually clear when used. Accordingly, while there are existing methods of producing clear ice, such clarity is not commonly found, especially in commercial outlets. Further by way of explanation and clarity, the occurrence of clear ice products occurs in nature in the form of icicles. Icicles or like structures freeze clear since they are frozen layer by layer from the inside out. This type of naturally progressive freezing allows gases contained within the water to naturally escape into the atmosphere prior or concurrent to freezing.

In addition to the above, one method currently being used to achieve clear ice is by freezing water slowly using insulated containers. This essentially allows the dissolved gases to naturally escape into the atmosphere prior to freezing. One disadvantage associated with this method is the necessity to maintain temperatures close to the freezing point of the liquid, which means that it takes an extended period of time for a liquid to reach a frozen state. This is not a desirable solution in that products intended for commercial and home use typically require a significantly faster turnaround time than the many hours and/or days it takes to freeze liquid slowly using this method.

There are also man-made ice machines that borrow this technique at least to the extent of creating a substantially constant agitation of a liquid as it freezes. Such continuous agitation causes the dissolved gases within the liquid being frozen to escape during the freezing process. Examples of this technology include ice machines that are manufactured by Clinebell Equipment Company of Loveland, Colo., a supplier of related equipment for the ice industry. While considered operative for their intended function, machines of this type are comparatively large and relatively costly. Therefore, known and/or existing equipment and procedures involved in the creation of visually clear ice products suffer from at least two major disadvantages. Namely, the water or other liquid being frozen needs to be constantly agitated and the resulting ice or other frozen product needs to remain frozen from its point or location of formation to its point or location of use, if it is to maintain its clarity.

Based on the above, it would be beneficial to have a simple low-cost procedure that facilitates forming ice or another frozen product from any of a variety of different liquids. Moreover, it would also be beneficial that the product resulting from an improved and proposed method could be transported and stored in a sealed state at room temperature or under non-refrigerated conditions, thus remaining in a liquid state and contained within a sealed container. Furthermore, the final product, when in a frozen state, could be marketed as completely sanitary, as it remains untouched by human hands until it is opened for consumption, and results in a significant savings of time, effort and capital.

In addition, it would also be advantageous to provide one or a plurality of sealed containers which are substantially completely filled with a liquid processed in an improved and proposed manner. Such processing would facilitate storage of the liquid within the container at room temperatures, and the subsequent freezing of the liquid while in the container, resulting in the production of substantially clear ice, or other frozen product. In more specific terms, the processing of water or other liquids in a new and improved manner would facilitate the storage for extended periods and the transportation of the contained, processed liquid, wherein the freezing thereof into a substantially clear ice product can be accomplished at a point of use on an as needed basis.

### SUMMARY OF THE INVENTION

The present invention is directed to a method of processing water and/or other liquids in a manner which facilitates the extended storage thereof in containers at room or ambient temperatures or at temperatures other than a reduced temperature environment. Moreover, the method of the present invention will result in the production of a substantially visually clear ice product, shaped or configured to correspond to the container in which it is stored. Further, the liquid may be frozen within the container, after a prolonged storage period and at the location where it is used, at any appropriate time prior to use.

The method of the present invention may be explained herein with primary reference to water being the processed liquid. However, the one or more embodiments of the method of the present invention may be used to process a variety of consumable and non-consumable liquids, with the result being that the freezing of the liquid, while in a sealed storage container, will result in the formation of a substantially visually clear frozen product. Therefore, liquids adaptable to be processed in accordance with the method of the present invention could include, but not be limited to, consumable and non-consumable liquids including juices, alcoholic beverages, sodas, vinegars, coffee, teas or even soaps and oils, among others.

The process may begin with using regular tap water or a liquid which is run through a reverse osmosis process (RO), distillation, or other filtration/demineralization processes, in order to significantly reduce the concentration of dissolved solids within the liquid. The existence of dissolved solids within a liquid negatively impacts ice clarity. Moreover, in at least one embodiment of the present method, the concentration of dissolved solids in the liquid is reduced to generally less than about 15 parts per million (ppm), such as is typical for water processed through a reverse osmosis process. In at least one further embodiment, the concentration of dissolved solids in the liquid is reduced to generally less than about 5 parts per million (ppm), such as is commonly observed in distilled water.

In addition, the method of the present invention also includes the reduction of the concentration of dissolved gases in the liquid to a concentration of less than about 5 ppm, and in one further embodiment, less than about 2 ppm, at the point where the liquid is being sealed in a container. Further reduction in the concentration of dissolved gases in the liquid may include a concentration of less than about 1 ppm, once again, at the point where the liquid is being sealed in a container. In at least one other embodiment, the dissolved gases in the liquid at the fill point is reduced to about 60 to 80 parts per billion (ppb), and in yet one further embodiment, the dissolved gases in the liquid at the fill point are reduced to about 3 to 8 ppb. Such reductions in dissolved gas concentrations may be accomplished utilizing commercially available or customized degasification equipment.

As will be explained in greater detail hereinafter, the reduction in the concentration of dissolved solids and the reduction in the concentration of dissolved gases may be accomplished using separate procedures in accordance with one or more embodiments of the method of the present invention. However, the procedures directed to the reduction of dissolved solids and gases may occur independent of one another and in any order.

Once the concentration of the dissolved gases in the liquid has been reduced to an appropriate and/or desired concentration, the method in accordance with at least one embodiment further comprises procedures for assuring that gases do not re-enter the liquid during additional processing. More specifically, at least some of the additional processing steps of the method in an embodiment employing an aseptic “cold fill” process at ambient temperatures may be conducted while subjecting the liquid to a vacuum. This can be accomplished through the provision of one or more vacuum pumps or other sources of negative pressure to which the liquid and/or the container is subjected under certain applied conditions and procedures. In at least one embodiment, the aforementioned negative pressure environment is maintained relative to both the liquid and the container during an aseptic “cold fill” process at ambient temperatures.

In addition to the above, in one other embodiment of the present method, prior to disposing the processed liquid into a container, the liquid is heated to a predetermined temperature, so as to accomplish and/or maintain a commercially sterile condition of the container and or liquid being processed. Heating the liquid to a predetermined temperature further inhibits dissolution of gases into the liquid during the filling and sealing processes. The liquid is maintained at about this predetermined temperature during the filling procedure. This approach is referred to as a “hot fill” in the beverage industry, and is typically reserved for consumable liquids such as teas, juices, sodas and flavored waters. However, in the processing of a liquid in accordance with the method of the present invention, the heated liquid not only assures a commercially sterile container and liquid, but the heat also acts as an inhibitor to the re-entry of gases into the liquid during the filling of the container.

Considering this, in at least one embodiment of the present invention, heating of the liquid is done before or soon after reducing the concentration of the dissolved gases in order to one embodiment, wherein the liquid being processed is water, the predetermined temperature is in a range of about 170° Fahrenheit to about 210° Fahrenheit, i.e., just up to but not reaching the boiling point under process conditions. In at least one other embodiment wherein water is being processed, the water is heated to a predetermined temperature of about 180° Fahrenheit. Of course, where other liquids are being processed via the present method, the predetermined temperature is dictated by the boiling point of the liquid being processing, and the predetermined temperature will be in a range commensurate therewith, i.e., just up to the corresponding boiling point of the liquid.

During the filling process, in accordance with at least one embodiment, an appropriate quantity of the heated liquid, dependent at least in part on the dimension and/or configuration of the container, is disposed within the container in an amount which substantially completely fills the container, thereby displacing any gases from the interior of the container with the heated liquid. In at least one further embodiment, a container is filled from the bottom-up so as to minimize agitation of the liquid in the container during the filling process, thereby minimizing the reintroduction of gases into the liquid during the filling process. Once completely substantially filled, the container is promptly sealed in a manner which prevents entrapment of gases between the surface of the heated liquid in the container and the container seal. In an embodiment wherein a container is substantially completely filled with a liquid, the container and/or seal are formed of a sufficiently flexible material, such as polyethylene or an extruded polyethylene having a thickness in a range of about 10 mil to about 30 mil, so as to allow for expansion of the liquid upon freezing. In yet one further embodiment wherein a container is substantially completely filled and the container comprises a rigid or semi-rigid construction, the container is structured to allow for incremental or ratcheted separation of components during freezing, so as to accommodate expansion of the ice or other frozen liquid in the sealed environment.

In at least one alternate embodiment, a container is only partially filled with the liquid so as to create a partial interior space sufficient to accommodate an expansion of the liquid as it is transformed from the liquid state to the solid or frozen state. In said later embodiment, an amount of an inert gas, including but not limited to nitrogen, argon, etc., is introduced into the headspace above the liquid in the container after filling but before the container is sealed. In one alternate embodiment, an inert gas may be introduced into a container before it is filled with a processed liquid, such that the processed liquid displaces the inert gas from the container during filling, thereby avoiding or at least minimizing contact of the liquid with the surrounding air. In one further embodiment, an inert gas is introduced into a container both before it is filled with a processed liquid and again into the headspace after filling the container with the processed liquid but before it is sealed, and in yet one further embodiment, the entire filing and sealing process is accomplished in an inert gas environment. In at least one embodiment, the inert gas introduced into the headspace is approved for use in the food packaging industry.

Once the container is filled with the liquid, it is sealed using an appropriate plug, foil seal, welding or other means of closure. However, the closure is applied to the container in a manner which establishes a substantially fluid tight seal, thereby effectively isolating the processed liquid within the interior of the container. As before, once a container is completely substantially filled, the container is promptly sealed in a manner which prevents entrapment of gases between the surface of the liquid in the container and the container seal. In one embodiment the fluid tight seal is sufficient to restrict the re-entry of gases back into the liquid within the interior of the container, while also serving to maintain the liquid in a commercially sterilized state.

As further explained, in an embodiment wherein the final frozen product is intended for human consumption, both the liquid and the container need to be commercially sterile, although such sterilization of the liquid and container do not have to be performed at the same time. To the contrary, commercial sterilization of the liquid as well as the container may be accomplished prior or subsequent to many of the various procedures of the present method, but specifically prior to the at least partial filling of the container with the liquid and subsequent fluid tight sealing thereof.

As used herein, the terms “sterile”, “sterility”, “commercial sterility”, or equivalents thereof are meant to describe a degree of sterility that complies with The Code of Federal Regulations, Title 21, Volume 2, which was revised as of Apr. 1, 2014 (21 CFR 113.3). In at least one embodiment, the present method is partially or completely implemented in a “clean room” environment to further assure that “commercial sterility” is achieved and maintained.

As also set forth in greater detail hereinafter, at any point during processing of the liquid and the container, vacuum pumps and storage tanks may be used in order to ensure the liquid moves through the various steps of the process efficiently. Also, a vacuum or negative pressure environment which minimizes or prevents remigration of gases into the liquid may be implemented at any point in the processing of the liquid or the container.

The benefits and advantages of the method of the present invention includes the ability to store and transport the containers and their liquid contents at room or ambient temperatures. In addition, when the contained liquid is eventually frozen, the result will be an ice product or like solid product, which is significantly and substantially visually clearer than ice and like frozen products made in accordance with currently known techniques.

Further by way of example, at least one category of containers which may be used to appropriately store liquid processed in accordance with the method of present invention includes the “SFIRO” container as disclosed in currently pending U.S. patent application Ser. No. 13/887,871, U.S. Provisional Patent Application Ser. No. 61/767,813, and Patent Cooperation Treaty Application Number PCT/US2014/017358, and the single use sealed containers as disclosed in U.S. Provisional Patent Application No. 61/029,081, each of which are incorporated herein in full by reference. Other containers may include the use of plastic and non-plastic bottles, trays, or other sealed container shapes including cylinders, blocks, or diamond or a variety of other decorative shapes and sizes.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of two alternate illustrative embodiments of a method in accordance with the present invention.

FIG. 2 is a schematic representation of one illustrative embodiment of a bench scale system for processing a liquid in accordance with the method of the present invention.

FIG. 3 is a schematic representation of one illustrative embodiment of a commercial scale system for processing a liquid in accordance with the method of the present invention.

Like reference numerals refer to like parts throughout the several views of the drawings.

### DETAILED DESCRIPTION

As represented in the accompanying figures, the present invention is directed to a method of processing liquids, specifically including but not limited to water, in a manner which facilitates the storage thereof in containers at ambient temperatures without requiring refrigeration during storage and/or transport prior to use. Moreover, the processing of a liquid in accordance with the present method results in the production of a substantially visually clear ice or frozen product, which may be shaped to substantially correspond to the configuration of the container in which the processed liquid is stored. Accordingly, the method of the present invention facilitates the processing of a variety of different liquids in a manner which allows the liquids to be stored within containers for prolonged periods of time and then to be frozen within the storage container at any appropriate time prior to use.

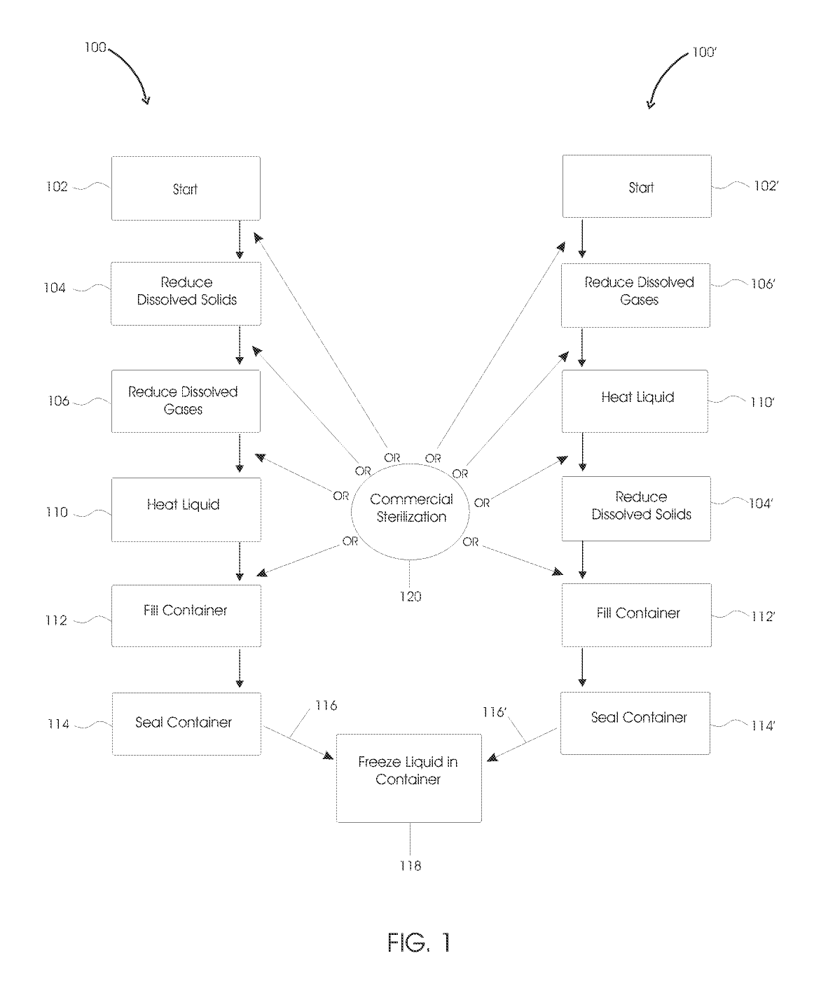

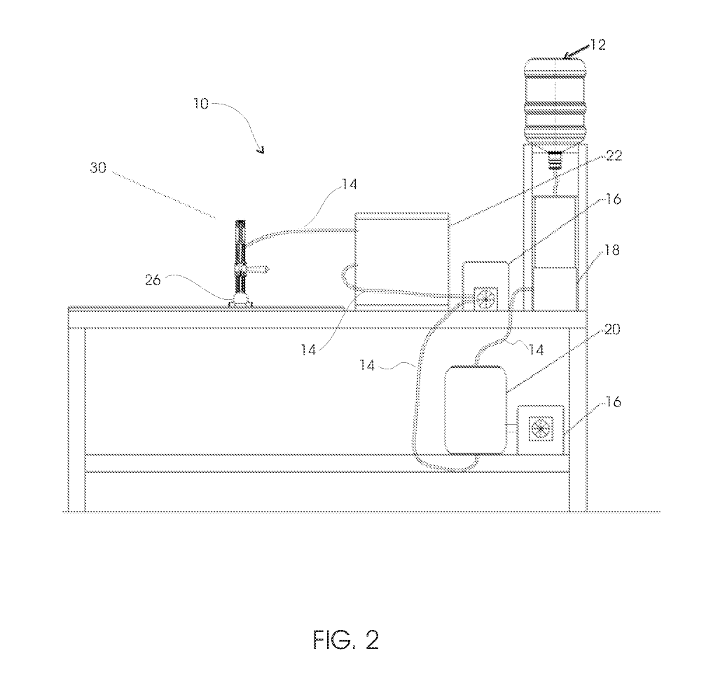

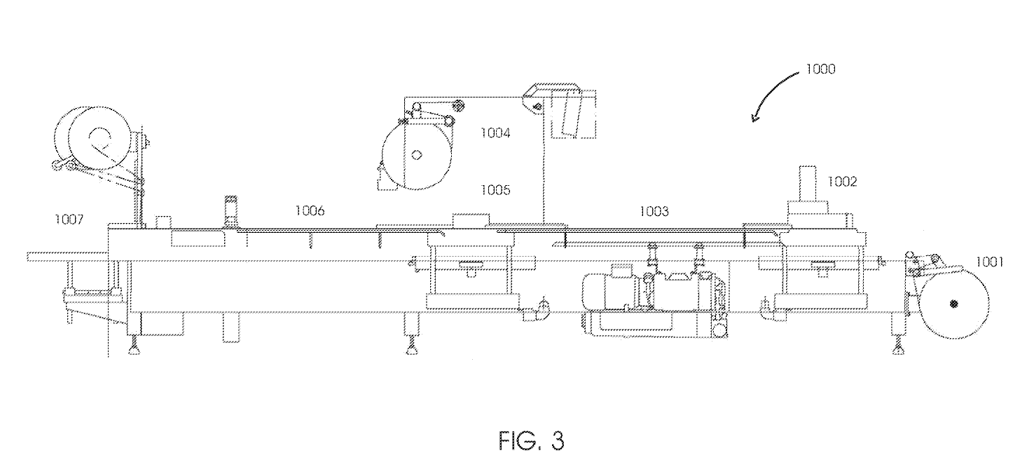

With primary reference to FIG. 1, the method of the present invention comprises at least one embodiment generally indicated as 100 and at least one alternate embodiment generally indicated as 100′. In addition, FIG. 2 is a schematic representation of a bench scale system 10 capable of implementing the method 100 and/or 100′ of the present invention. FIG. 3 is illustrative of one embodiment of a commercial scale system 1000 for processing a liquid in accordance with the method of the present invention. However, the schematic representations of FIGS. 2 and 3 are merely exemplary of actual systems which may be utilized to implement the method 100, 100′ in accordance with the present invention. Accordingly, the various operative components, assemblies, devices, etc., in the bench scale system 10 or the commercial scale system 1000 may vary in size, shape, number, and relative location dependent, at least in part, on the type of liquid being processed, the volume of liquid being processed, and the order of the various processing steps in the one or more embodiments 100, 100′, etc., of the present method.

With further regard to FIG. 2, the processing facility 10 includes a liquid supply generally indicated as 12. The liquid supply 12 may include tap water, distilled water, alcoholic beverages, sodas, vinegars, coffee, teas or even soaps and oils, as noted above. The liquid supply 12 is connected in fluid communication to the remaining components or assemblies of the processing facility 10 by a plurality of appropriately disposed and structured conduits 14. In addition, one or more pumps 16, which may comprise either positive pressure or vacuum pumps, are connected in fluid communication throughout the processing facility 10 in order to facilitate flow of the processed liquid from the supply 12 throughout the processing facility 10. However, as will be explained in greater detail with regard to at least one embodiment 100, 100′ of the present method, such as while “cold filling” containers in an aseptic environment, at least certain ones of the processing steps may be conducted and performed in a vacuum or negative pressure environment.

Further, with regard to the processing facility 10, a degasification unit 18 is provided in communicating relation with the supply 12. The degasification unit 18 is operative to reduce the concentration of dissolved gases in the liquid being processed to an appropriate and desired concentration. In addition, a storage container 20 may be provided to receive and store the processed liquid subsequent to the reduction of the concentrations of both dissolved solids and dissolved gases originally contained in the liquid supply 12. As again noted, some of the processing steps involved in at least one embodiment of the present method 100, 100′ are conducted while being subjected to a vacuum or negative pressure. Accordingly, in one embodiment, vacuum pumps 16 may be operatively connected to draw an appropriate negative pressure on the processed liquid during and prior to the reduction of the concentration of dissolved solids and/or dissolved gases in the liquid being processed.

Additional features of the processing facility 10 include a liquid heater generally indicated as 22. As explained in greater detail below with regard to some embodiments 100 and 100′ of the present method, the processed liquid is heated to a predetermined temperature prior to at least partially filling one or more containers 26. More specifically, the liquid being processed is heated to a temperature during the filling procedure. This approach is referred to as “hot fill” in the beverage industry and is typically used in the processing and filling of containers with consumable liquids. As also schematically represented in FIG. 1, the processing facility 10 also includes a filling station generally indicated as 30, wherein the processed liquid is delivered to the interior of an empty storage container 26. Further, the closing of the container 26 and the sealing thereof may occur under the influence of a vacuum, in at least one embodiment, in order to eliminate or significantly restrict the re-entry of gases into the processed liquid once it is stored in sealed within the container 26.

FIG. 3, as noted above, is illustrative of one embodiment of a commercial scale system 1000 for use in at least partially implementing the method 100, 100′ of the present invention. More in particular, FIG. 3 is illustrative of an automated manufacturing system 1000 that includes a form fill and seal machine. In at least one embodiment, a Model R530 form fill and seal machine as manufactured by MultiVac is utilized to implement the present method 100, 100′. Of course, it will be appreciated by those of skill in the art that other models and/or manufacturers of such equipment may be utilized.

To begin, the system 1000 includes a bottom web material 1001 that is fed into a form station 1002. The mold station 1002 molds the bottom web material 1001 into a desired container shape which may include cubes, rectangles, or other shapes. The empty containers 26 (not shown) proceed to a filling station 1003 wherein the containers 26 are then either “hot filled” or “cold filled”, in the manner described above, with a liquid which has been processed in accordance with method 100, 100′ herein so as to reduce dissolved solids 104 and to reduce dissolved gases 106. The filling station 1003, in at least one embodiment, employs one or more vent tubes to fill the containers 26 in a manner which minimizes agitation of the processed liquid during the filling process to help prevent reintroduction of air or other gases into the processed liquid. This may include them filling the containers 26 with the processed liquids from the bottom up.

After either “hot filling” or “cold filling” containers 26, the filled containers 26 proceed to a sealing station 1005 wherein a top web material 1004 is secured overtop of the liquid in the bottom web material 1001, now formed into containers 26, utilizing any of a variety of sealing methods including but not limited to heat, induction, sonic, or adhesive sealing.

It is important to note that minimizing the amount of time between the filling station 1003 and the sealing station 1005 is essential in order to minimize gas ingress into the processed liquid in the containers. Also, and as noted above, the top web material 1004 is positioned overtop of the formed containers 26, and more importantly, above the surface of the processed liquid contained therein, in a manner which minimizes entrapment of air between the top web material 1004 and the liquid, once again, so as to minimize the reintroduction of air or other gases into the processed liquid in containers 26. Likewise, in an embodiment of the present method 100, 100′ wherein “cold filling” is performed in an aseptic environment, one or more of the operative steps may be performed under a vacuum, once again, to minimize the reintroduction of air or other gasses into the processed liquid.

Once the processed liquid is sealed in containers 26, the system 1000, in accordance with one embodiment, transfers the sealed liquid containers to a cutting station 1006 wherein the containers 26 are separated from one another and are jettisoned from the machine at a finished product station 1007.

In at least one further embodiment of the system 1000, a cooling station (not shown) is provided to sufficiently cool the processed liquid in the sealed containers 26 (not shown) so as to prevent deformation of the sealed containers 26 following a “hot fill”. In at least one embodiment, such a cooling station is provided prior to or following a cutting station 1006.

With primary reference to FIG. 1, and more specifically to the illustrative embodiment 100 of the present method, the process begins as at 102 with the liquid supply being disposed in fluid communication with the remainder of the components associated with a processing facility. More specifically, water or other appropriate liquid may first be exposed to a reverse, osmosis procedure (RO). In the alternative, distillation or other filtration/demineralization processes may be used in order to significantly reduce the concentration of dissolved solids 104 in the liquid being processed. Moreover, in the embodiment 100, the concentration of dissolved solids in the liquid being processed is reduced to a concentration of generally less than about 15 parts per million (ppm), such as is typical for water processed through a reverse osmosis process. In at least one further embodiment, the concentration of dissolved solids in the liquid is reduced to generally less than about 5 parts per million (ppm), such as is commonly observed in distilled water.

As also indicated, the embodiment 100 includes the reduction of the concentration of dissolved gases 106 in the liquid to a concentration of less than about 2 ppm, at the point where the liquid is being sealed in a container. However, a further reduction in the concentration of dissolved gases in the liquid being processed may include a concentration of less than about 1 ppm, once again, at the point where the liquid is being sealed in a the liquid at the fill point is reduced to about 60 to 80 parts per billion (ppb), and in yet one further embodiment, the dissolved gases in the liquid at the fill point are reduced to about 3 to 8 ppb. As also schematically indicated in FIG. 2, such reductions may be accomplished utilizing a commercial or customized degasification unit 18.

As also represented in FIG. 1, once the concentration of dissolved gases within the liquid has been reduced to an appropriate concentration, the liquid may be subjected to a vacuum or predetermined negative pressure in embodiments of the present method 100, 100′ employing a “cold fill” technique. The negative pressure environment serves to minimize or prevent the reentry of gasses into the liquid during the various processing steps during a “cold fill”. Further, the vacuum or negative pressure environment may be maintained throughout a remainder or specific ones of the processing steps in the present method 100, 100′, once again, while a “cold fill” technique is being employed.

As further indicated in FIG. 1, subsequent to the reduction of dissolved gases, in an embodiment employing a “hot fill” technique, the liquid is heated as at 110, such as, utilizing the heater 22 of the processing facilities 10. In at least one embodiment, the predetermined temperature is in a range of about 170° Fahrenheit to about 210° Fahrenheit, or just up to the boiling point of the liquid as dictated by specific process conditions, such as process pressure, while in at least one other embodiment, the predetermined temperature is about 180° Fahrenheit.

In accordance with at least one embodiment of the present method 100, 100′, an appropriate quantity of the heated liquid, dependent at least in part on the dimension and/or configuration of the container, is disposed within the container in an amount such that the container is substantially completely filled as at 112, 112′, thereby displacing any gases from the interior of the container with the heated liquid. As used herein, the phrase “substantially completely filled” shall mean that a container 26 is filled with an amount of a processed liquid in such a manner that essentially no head space exists above the processed liquid at the time of sealing the container, as at 114, 144′. Thus, when a container 26 is “substantially completely filled” with a processed liquid, it prevents, or at least minimizes, entrapment of any air or other gases in the container 26 with the processed liquid at the time the container is sealed.

In at least one further embodiment, a container is filled from the bottom-up so as to minimize agitation of the liquid in the container during the filling process, thereby further preventing or minimizing the reintroduction of gases into the liquid during the filling process. Once substantially completely filled, the container 26 is promptly sealed in a manner which prevents entrapment of gases between the surface of the heated liquid in the container and the container seal, such as at 114, 114′.

In an embodiment wherein a container 26 is substantially completely filled with a liquid, the container and/or seal are formed of a sufficiently flexible material to allow for expansion of the liquid upon freezing. In yet one further embodiment wherein a container 26 is substantially completely filled and the container comprises a rigid or semi-rigid construction is utilized, the container 26 is structured to allow for incremental or ratcheted separation of components during freezing, so as to accommodate expansion of the ice in the sealed environment.

It is noted that in at least one embodiment, a container 26 is “partially filled” such that a head space remains on the interior thereof. This head space is sufficiently disposed and dimensioned to accommodate an expansion of the liquid within the container 26 once it is subjected to a reduced temperature sufficient for freezing. Accordingly, once the container 26 is “partially filled” an appropriate inert gas is added to substantially and completely occupy the head space, after which, the container is closed and a fluid tight seal 114 is applied. As previously indicated, in at least one embodiment, an appropriate inert gas includes but is not limited to argon, nitrogen, or any other inert gas deemed appropriate for food grade service. The utilization of a fluid tight seal 114 has the advantage of effectively isolating the liquid within the interior of the container 26. As also indicated above, the closing and sealing of the container when at least partially filled by the processed liquid and an inert gas, further serves to restrict re-entry of gases into the stored and processed liquid.

As generally indicated at 116, once the container 26 is filled with the processed liquid and appropriately sealed, whether substantially completely filled or partially filled and having an inert gas in the head space, it may be stored for a prolonged period. Such an extended period of storage may last days, weeks, months, etc. During storage, the container and liquid contents may be transported to a site or location of use. Once ready for use, the container and the contained liquid may be frozen, as at 118, at an appropriate time before use. Of course, in at least one embodiment, the container and the contained liquid may be immediately subjected to freezing, such as for immediate consumption, for transport to a final point of use in a frozen state, etc. When frozen, the resulting ice or frozen product will be substantially visually clear and assume a corresponding or substantially similar shape and size of the container in which it is stored.

As also represented in the illustrative embodiments of FIG. 1, both the liquid being processed and the container 26 need to be made commercially sterile as generally indicated at 120. However, the commercial sterilization process may be performed, individually or in combination on the liquid and container 26, at any one of the plurality of processing steps and procedures throughout the illustrative embodiments of the method 100, 100′. Further, such commercial sterilization of the liquid and the container 26 need not take place during the same processing step or procedure. To the contrary, the liquid and the container 26 may be separately sterilized. As used herein, the term “commercial sterility” or its equivalent is meant to describe a degree of sterilization that complies with The Code of Federal Regulations, Title 21, Volume 2, as revised on Apr. 1, 2014 (21 CFR 113.3).

As set forth above and as clearly represented in FIG. 1, the method for processing liquid of the present invention comprises at least one additional or alternative embodiment 100′. A review and comparison of the illustrative embodiments 100 and 100′ indicates that the processing steps are substantially equivalent with the exception of the order in which such processing steps are performed. More specifically, in the alternate embodiment of the method 100′, the liquid being processed first undergoes the reduction of the dissolved gases 106′ to a predetermined concentration, as in the embodiment of the method at 100. Thus, reduction of the dissolved gases 106′ to the desired concentration in the alternate embodiment of method 100′ occurs prior to the reduction of the concentration of the dissolved solids as at 104′, and thereby differs from the embodiment of the method 100 of the present invention. As before, when employing a “cold fill” technique, once the concentration of dissolved gases within the liquid has been reduced below the desired concentration, the liquid may be subjected to a predetermined negative pressure or vacuum. Such negative pressure environment may be maintained throughout the remainder of the processing steps of the alternate embodiment of the method 100′ up to and including filling and sealing of the container 26, as at 112′ and 114′.

Similarly, in the alternate embodiment of the method 100′, commercial sterilization 120 of both the liquid and the container 26 may occur at any of a plurality of processing steps throughout the present method. It is noteworthy that while the present method 100, 100′ may be employed to produce a frozen liquid product suitable for human consumption, in at least one embodiment, the present invention may be employed to produce a frozen liquid product for non-consumption purposes. As just one example, the present method 100, 100′ may be utilized to produce large blocks of clear frozen water for use in ice sculptures, in which case, “commercial sterility” is not a requirement.

Therefore, the benefits, advantages, and versatility of the present method 100, 100′, etc., is evidenced by allowing the containers and their liquid contents to be stored and transported at room or ambient temperature. In addition, when the container and the processed liquid contents thereof are eventually frozen, ice or a like solid frozen product will result. Moreover, the visual clarity of the resulting ice or solid frozen product will be significantly clearer than ice and like frozen products made in accord with known conventional techniques. As indicated, such visual clarity is due at least in part to the fact that the concentration of both dissolved solids and dissolved gases in the liquid has been reduced. In addition exposure of the processed liquid to air or other gases during the processing thereof and/or the filling and sealing of the selected storage containers is minimized throughout the process. Further, the selection of the materials for the container and the seals used to restrict exposure of the contained liquid includes sufficient gas-barrier characteristics to minimize or prevent ingress of gases into the processed liquid in the sealed containers.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of processing a liquid for storage in a container to facilitate producing a substantially visually clear frozen product, the method comprising:
reducing a dissolved solids concentration of the liquid to at least a predetermined concentration,
reducing a dissolved gas concentration of the liquid to at least a predetermined concentration,
heating the liquid to at least a predetermined temperature,
filling a container with the heated liquid until the container is substantially completely filled, and
sealing the substantially completely filled container.

2. The method as recited in claim 1 further comprising reducing the dissolved solids concentration of the liquid to a predetermined concentration of less than about 15 parts per million.

3. The method as recited in claim 1 further comprising reducing the dissolved solids concentration of the liquid to a predetermined concentration of less than about 5 parts per million.

4. The method as recited in claim 1 further comprising reducing the dissolved solids concentration of the liquid to a predetermined concentration of less than about 2 parts per million.

5. The method as recited in claim 3 further comprising reducing the dissolved gas concentration of the liquid to a predetermined concentration of less than about 1 parts per million at the point of filling the container.

6. The method as recited in claim 1 further comprising reducing the dissolved gas concentration in the liquid to a predetermined concentration of less than about 2 parts per million at the point of filling the container.

7. The method as recited in claim 1 further comprising reducing the dissolved gas concentration in the liquid to a predetermined concentration of less than about 1 parts per million at the point of filling the container.

8. The method as recited in claim 5 further comprising sealing the container with a fluid tight seal.

9. The method as recited in claim 1 further comprising sealing the container with a fluid tight seal.

10. The method as recited in claim 1 further comprising heating the liquid to a temperature in a range of about 170° Fahrenheit to about 210° Fahrenheit.

11. The method as recited in claim 1 further comprising heating the liquid to a temperature of at least 180° Fahrenheit.

12. The method as recited in claim 1 further comprising commercially sterilizing the liquid.

13. The method as recited in claim 12 further comprising commercially sterilizing the container.

14. The method as recited in claim 1 further comprising reducing the dissolved solids concentration in the liquid prior to reducing the dissolved gas concentration in the liquid.

15. The method as recited in claim 1 further comprising reducing the dissolved gas concentration in the liquid prior to reducing the dissolved solids concentration in the liquid.

16. A method of processing liquid for storage in a container to facilitate producing a substantially visually clear frozen product, the method comprising:
commercially sterilizing the liquid,
reducing a dissolved solids concentration of the commercially sterilized liquid to at least a predetermined concentration,
reducing a dissolved gas concentration of the commercially sterilized liquid to at least a predetermined concentration,
heating the commercially sterilized liquid to at least a predetermined temperature,
filling a commercially sterilized container with the heated commercially sterilized liquid until the commercially sterilized container is substantially completely filled with the heated commercially sterilized liquid, and
sealing the substantially completely filled commercially sterilized container with a substantially fluid tight seal.

17. The method as recited in claim 16 comprising heating the commercially sterilized liquid to a temperature of generally about 180° Fahrenheit.

18. The method as recited in claim 17 further comprising reducing the dissolved solids concentration in the commercially sterilized liquid to a predetermined concentration of less than about 5 parts per million.

19. The method as recited in claim 18 comprising reducing the dissolved gas concentration in the commercially sterilized liquid to a predetermined concentration of less than about 2 parts per million.

20. The method as recited in claim 18 comprising reducing the dissolved gas concentration in the commercially sterilized liquid to a predetermined concentration of less than about 1 parts per million.
